(19) United States
(12) Patent Application Publication
(10) Pub. No.: US 2026/0326243 A1
(43) Pub. Date: Oct. 22, 2026

(54) WELDING JIG HAVING SLIDE TABLE

(71) Applicant: FCA US LLC, Auburn Hills, MI (US)

(72) Inventors: Han YANG, Shanghai (CN); Fanhui ZHANG, Shanghai (CN); Chunmei FAN, Shanghai (CN)

(21) Appl. No.: 19/181,488

(22) Filed: Apr. 17, 2025

(51) Int. Cl. B23K 37/02; B25J 11/00

(52) U.S. Cl. CPC B23K 37/0211; B25J 11/005

(57) ABSTRACT

A welding station including a jig attached to a support structure and movable between a loading zone and a welding zone. A first robot is positioned proximate the loading zone for attaching a first workpiece to the jig. A plurality of second robots are positioned proximate the welding zone for conducting first welding operations on the first workpiece when the workpiece is attached to the jig. A third robot is positioned proximate the welding zone and configured, after the plurality of second robots have concluded the first welding operations, to grasp the first workpiece and suspend the first workpiece proximate to or over the welding zone where the second robots can conduct second welding operations on the first workpiece while the first workpiece is suspended, and the jig can be moved back to the loading zone to receive a second workpiece.

### FIELD

The present disclosure relates to a welding jig having a slide table.

### BACKGROUND

This section provides background information related to the present disclosure which is not necessarily prior art.

As vehicle manufacturing continues to evolve, the use of robots has become more and more prevalent. The capital costs associated with using robots, however, can be significant. In addition, manufacturing facilities may have space constraints that may prohibit multiple stations of various robots to conduct various procedures. It is desirable, therefore, to maximize the amount of space in a manufacturing facility while being able to use a fewer number of robots to reduce capital costs.

### SUMMARY

This section provides a general summary of the disclosure, and is not a comprehensive disclosure of its full scope or all of its features.

According to an aspect of the present disclosure, there is provided a welding station for conducting a plurality of welding operations on a workpiece. The welding station may include a support structure including a loading zone and a welding zone; a jig attached to the support structure and movable between the loading zone and the welding zone; a first robot positioned proximate the loading zone for attaching a first workpiece to the jig when the jig is positioned in the loading zone; a plurality of second robots positioned proximate the welding zone for conducting first welding operations on the first workpiece when the workpiece is attached to the jig and the jig is positioned in the welding zone; and a third robot positioned proximate the welding zone and configured, after the plurality of second robots have concluded the first welding operations, to grasp the first workpiece and suspend the first workpiece proximate to or over the welding zone where the second robots can conduct second welding operations on the first workpiece while the first workpiece is suspended, wherein while the second robots are conducting the second welding operations on the first workpiece while it is suspended, the jig is configured to move from the welding zone back to the loading zone to have a second workpiece attached to the jig by the first robot, and after the second robots have concluded the second welding operations on the first workpiece, the jig including the second workpiece is configured to move from the loading zone back to the welding zone so that the second robots can conduct the first welding operations on the first workpiece.

According to the aspect, the support structure includes a pair of support rails and a toothed rail positioned between the support rails, and a motor attached to the jig is configured to rotate a toothed gear to translate the jig along the toothed rail between the loading zone and the welding zone.

According to the aspect, the welding station may also include a controller that is in communication with and configured to control the first robot, the plurality of second robots, the third robot, and the motor.

According to the aspect, the jig is attached to a support tray, and the motor is attached to the support tray.

According to the aspect, the jig includes a mounting plate attached to the support tray, the mounting plate has a plurality of upstanding support fixtures that are fixed to and positioned about mounting plate for supporting the first and second workpieces.

According to the aspect, each of the first robot, the plurality of second robots, and the third robot are six-axis robots.

According to the aspect, the first and second workpieces are panels of an automobile.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an overhead perspective view of a welding station according to a principle of the present disclosure;

FIG. 2 is an isometric perspective view of a support structure having a jig for supporting a workpiece that is part of the welding station illustrated in FIG. 1;

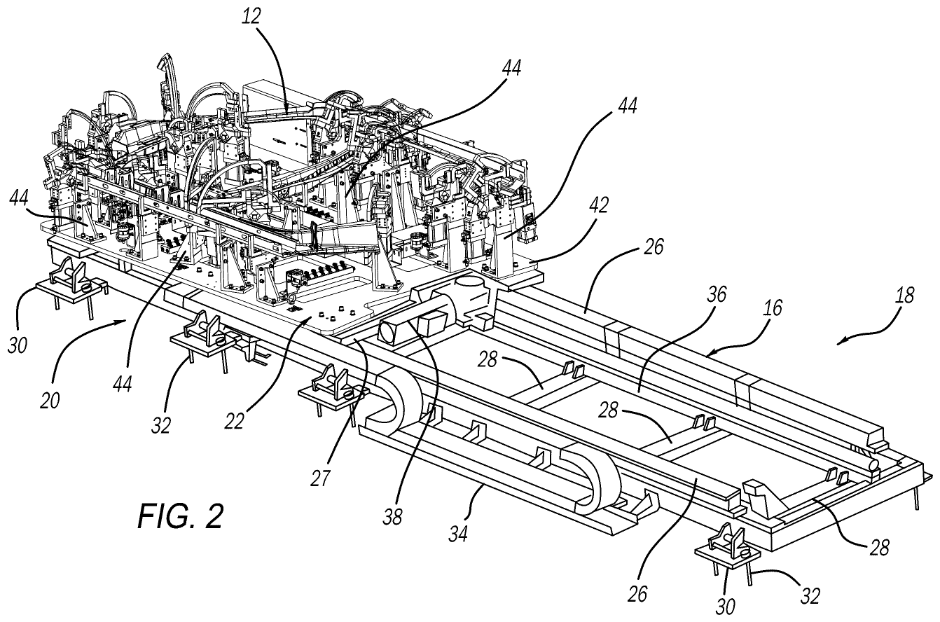

FIG. 3 is an overhead perspective view of the support structure having the jig for supporting a workpiece that is illustrated in FIG. 2;

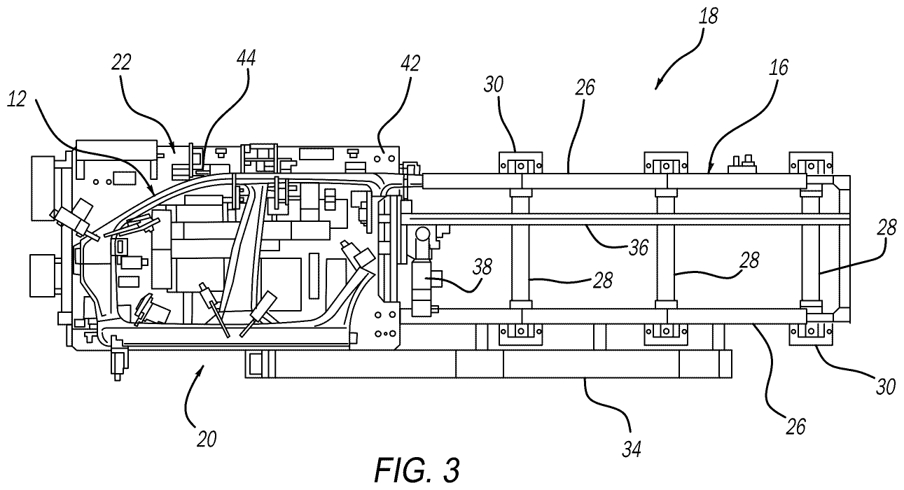

FIG. 4 is a bottom perspective view of the support structure having the jig for supporting a workpiece that is illustrated in FIG. 2;

FIG. 5 is a schematic diagram illustrating various features of the welding station illustrated in FIG. 1 in communication and configured to be controlled by a controller, according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

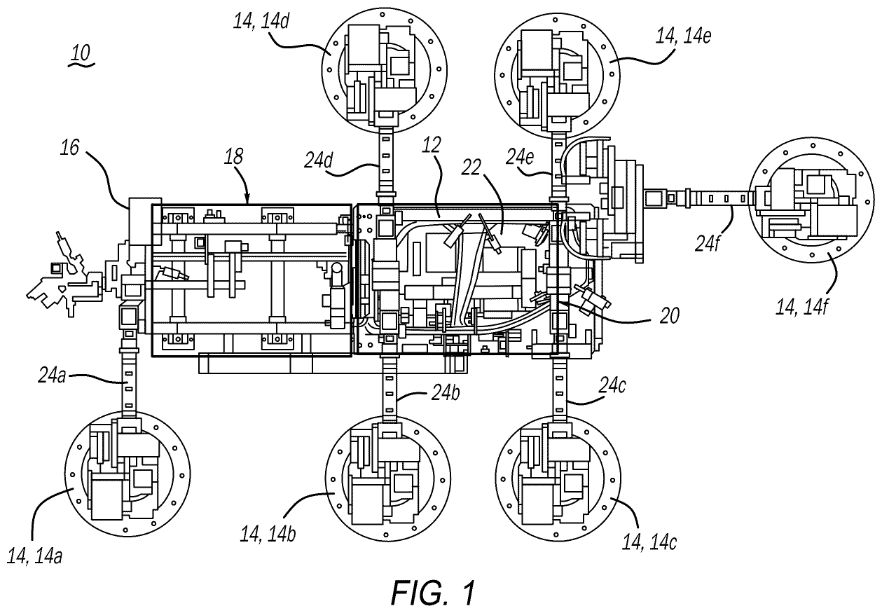

FIG. 1 illustrates an example station 10 for simultaneously conducting loading and welding operations of a workpiece 12 such as a vehicle body panel that can reduce the amount of space and number of robots 14 in a manufacturing facility necessary to conduct these operations. Station 10 includes a support structure 16 that includes a loading zone 18 and a welding zone 20. A jig 22 that is configured to support workpiece 12 (e.g., a first workpiece) is attached to the support structure 16, and movable between the loading zone 18 and the welding zone 20.

Robots 14 include a first robot 14a that is configured to locate the workpiece 12 onto jig 22 when jig 22 is in the loading zone 18; second, third, fourth, and fifth robots 14b-14e for conducting first welding operations on the workpiece 12 when workpiece 12 is attached to the jig 22 and the jig 22 is in the welding zone 20; and a sixth robot 14f that is configured to grasp the workpiece 12 after the second to fifth robots 14b-14e have concluded the first welding operations when workpiece 12 is attached to the jig 22, suspend the workpiece 12 over or proximate to the welding zone 20, and permit the second to fifth robots 14b-14e to continue welding operations (i.e., second welding operations) on the workpiece 12 while the workpiece 12 is suspended by the sixth robot 14f.

When the workpiece 12 is suspended over or proximate to the welding zone 20 and the second to fifth robots 14b-14e continue the second welding operations on the workpiece 12, the jig 22 is moved back to the loading zone 18, the first robot 14a locates another workpiece 12 (i.e., a second workpiece) onto jig 22, and the jig 22 is again moved to the welding zone 20. After concluding the second welding operations on the first workpiece 12 being suspended by sixth robot 14f, the second to fifth robots 14b-14e can return (i.e., rotate toward) to welding zone 20 where the second workpiece 12 has already been located and conduct the first welding operations on the second workpiece 12 to repeat the process. In this manner, manufacturing time and efficiency are improved, and the amount of space associated with station 10 can be reduced. In addition, because welding operations can be conducted on workpieces 12 while they are suspended by sixth robot 14f, the capital costs associated with an increased number of robots 14 can also be reduced because another station 10 having additional robots 14 is not necessary to make these welds. Put another way, because robots 14b-14e can be used to conduct two welding operations (i.e., a first welding operation when workpiece 12 is attached to jig 22 and a second welding operation when workpiece 12 is suspended by sixth robot 14f), the need for another station 10 having additional robots 14 is no longer necessary.

Robots 14a-14f can each be multi-axis robots such as six-axis robots, with robots 14b-14e having welding guns (not shown) attached to an end of an arm 24b, 24c, 24d, and 24e, respectively, and robots 14a and 14f having a gripping feature (not shown) attached to an arm 24a, 24f, respectively. In this manner, robots 14a and 14f can be used to grasp and lift workpiece 12 and robots 14b-14e can be used to conduct welding operations on workpiece 12.

Support structure 16 includes a pair of support rails 26 for supporting a movable support tray 27 that supports jig 22 in each of the loading zone 18 and welding zone 20. Support rails 26 and tray 27 may each be formed of a rigid metal material such as steel. A plurality of cross-beams 28 that may also be formed of a rigid metal material such as steel extend between each of the support rails 26. A plurality of pads 30 may be provided at a terminal end of each of the cross-beams 28 that can be secured to a floor (not shown) of a manufacturing facility using a plurality of fasteners 32, which may be bolts.

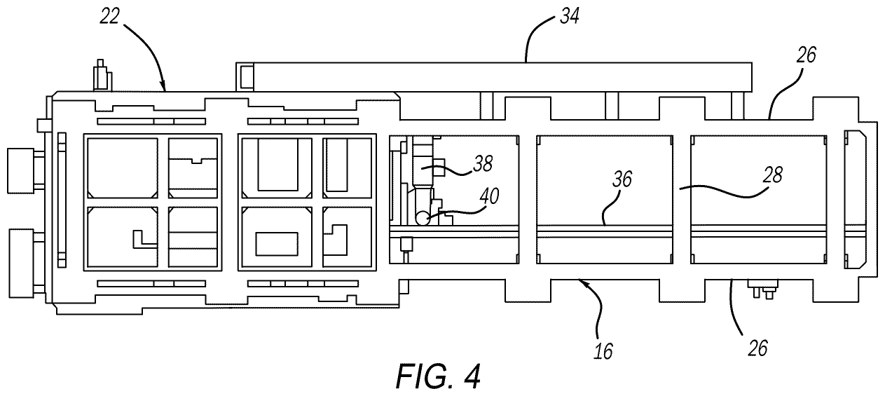

Support tray 27 is movable relative to support rails 26 between loading zone 18 and welding zone 20 by a track system 34 that may be attached to one of the support rails 26. Support structure 26 additionally includes a longitudinally extending toothed rail 36 that is positioned between and attached to support tray 27 and one of the cross-beams 28. An electric motor 38 may be attached to support tray 27, where electric motor 38 is configured to rotate a toothed gear 40 (FIG. 4) that mates with toothed rail 36. As gear 40 is rotated by motor 38, support tray 27 can be moved between loading zone 18 and welding zone 20 by travelling along track system 34 and toothed rail 36.

Jig 22 includes a mounting plate 42 fixedly attached to support tray 27 such that jig 22 can be movable between loading zone 18 and welding zone 20 along with support tray 27. A plurality of upstanding support fixtures 44 are fixed to and positioned about mounting plate 42. Support fixtures 44 are configured to support workpiece 12 in the desired orientation that permits robots 14b-14e to conduct welding operations on workpiece 12 when workpiece 12 is in the welding zone 20. Depending on the type and size of workpiece 12, the number, size, and position of support fixtures 44 is variable. In the illustrated embodiment, workpiece 12 is a panel for an automobile.

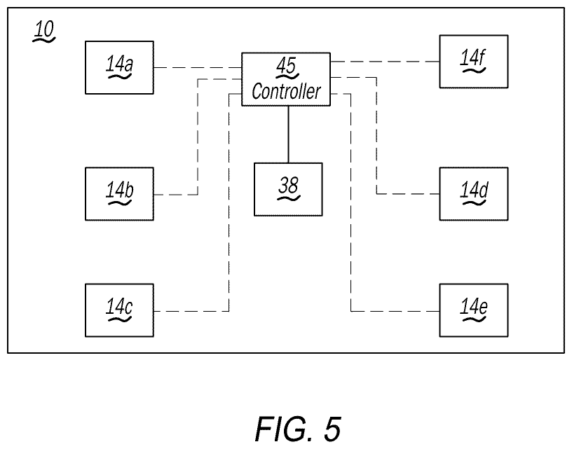

Now referring to FIG. 5, it can be seen that station 10 includes a controller 45 that is in communication with and configured to control motor 38 and each of the robots 14a-14f. Controller 45 may be, for example, a computer or some other type of control device. In any event, based on instructions received from controller 45, a workpiece 12 may be loaded onto jig 22 by first robot 14a when jig 22 is positioned in loading zone 18. After workpiece 12 is mated with jig 22, controller 45 may then operate electric motor 38 to rotate toothed gear 40 and translate the support tray 27, jig 22, and workpiece 12 along toothed rail 36 and track system 34 from the loading zone 18 to the welding zone 20.

After reaching welding zone 20, controller 45 may communicate with and control operation of second to fifth robots 14b, 14c, 14d, and 14e to conduct welding operations on workpiece 12 while workpiece 12 is mated with jig 22. After welding operations while workpiece 12 is mated with jig 22 have concluded, controller 45 may then communicate with and control sixth robot 14f to grasp workpiece 12, detach workpiece 12 from jig 22, and suspend workpiece 12 proximate to or over jig 22. While workpiece 12 is suspended by sixth robot 14f, controller 45 may then communicate with and control second to fifth robots 14b-14e to continue welding operations on workpiece 12, while also instructing motor 38 to rotate toothed gear 40 in an opposite direction to move support tray 27 and jig 22 along toothed rail 36 and track system 34 from welding zone 20 back to loading zone 18.

Once support tray 27 and jig 22 have arrived back at loading zone 18, controller 45 may then communicate with and control first robot 14a to grasp another workpiece 12 and attach the new workpiece 12 to jig 22. Then, controller 45 can again instruct and control motor 38 to rotate toothed gear 40 to move support tray 27 and jig 22 including workpiece 12 attached thereto along toothed rail 36 and track system 34 from loading zone 18 back to welding zone 20. By the time that the new workpiece 12 has reached welding zone 20, the second to fifth robots 14b-14e will have concluded welding operations on the workpiece 12 suspended by sixth robot 14f and will be available to be controlled by controller 45 to begin welding operations on the new workpiece 12 attached to jig 22, and the process can repeat itself.

In this manner, a reduction in time in conducting welding operations on the workpieces 12 can be reduced. In addition, because sixth robot 14f can be used to suspend a workpiece 12 and permit the second to fifth robots 14b-14e to continue welding operations while the tray 27 and jig 22 moves back to the loading zone 18 to receive a new workpiece 12 by first robot 14a, multiple stations having multiple robots 14 are not necessary and the amount of space that station 10 requires in a manufacturing facility can be reduced while expanding the efficiency of the station 10. Accordingly, the capital costs associated with a station 10 according to the present disclosure can also be reduced.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A welding station for conducting a plurality of welding operations on a workpiece, the welding station comprising:
a support structure including a loading zone and a welding zone;
a jig attached to the support structure and movable between the loading zone and the welding zone;
a first robot positioned proximate the loading zone for attaching a first workpiece to the jig when the jig is positioned in the loading zone;
a plurality of second robots positioned proximate the welding zone for conducting first welding operations on the first workpiece when the workpiece is attached to the jig and the jig is positioned in the welding zone; and
a third robot positioned proximate the welding zone and configured, after the plurality of second robots have concluded the first welding operations, to grasp the first workpiece and suspend the first workpiece proximate to or over the welding zone where the second robots can conduct second welding operations on the first workpiece while the first workpiece is suspended,
wherein while the second robots are conducting the second welding operations on the first workpiece while it is suspended, the jig is configured to move from the welding zone back to the loading zone to have a second workpiece attached to the jig by the first robot, and
after the second robots have concluded the second welding operations on the first workpiece, the jig including the second workpiece is configured to move from the loading zone back to the welding zone so that the second robots can conduct the first welding operations on the first workpiece.

2. The welding station according to claim 1, wherein the support structure includes a pair of support rails and a toothed rail positioned between the support rails, and a motor attached to the jig is configured to rotate a toothed gear to translate the jig along the toothed rail between the loading zone and the welding zone.

3. The welding station according to claim 2, further comprising a controller that is in communication with and configured to control the first robot, the plurality of second robots, the third robot, and the motor.

4. The welding station according to claim 1, wherein the jig is attached to a support tray, and the motor is attached to the support tray.

5. The welding station according to claim 4, wherein the jig includes a mounting plate attached to the support tray, the mounting plate has a plurality of upstanding support fixtures that are fixed to and positioned about mounting plate for supporting the first and second workpieces.

6. The welding station according to claim 1, wherein each of the first robot, the plurality of second robots, and the third robot are six-axis robots.

7. The welding station according to claim 1, wherein the first and second workpieces are panels of an automobile.
